(19) United States
(12) Patent Application Publication
(10) Pub. No.: US 2016/0327832 A1
(43) Pub. Date: Nov. 10, 2016

(54) BACKLIGHT MODULE AND DISPLAY DEVICE

(71) Applicant: BOE TECHNOLOGY GROUP CO., LTD., Beijing (CN)

(72) Inventors: Lin ZHU, Beijing (CN); Yanbing WU, Beijing (CN)

(73) Assignee: BOE TECHNOLOGY GROUP CO., LTD., Beijing (CN)

(21) Appl. No.: 14/780,349

(22) PCT Filed: Mar. 16, 2015
(86) PCT No.: PCT/CN2015/074267

§ 371 Date: Sep. 25, 2015

(30) Foreign Application Priority Data
Oct. 22, 2014 (CN) 201410568932.6

(51) Int. Cl. G02F 1/1335; G02F 1/1339; G02F 1/1337

(52) U.S. Cl. CPC G02F 1/133603; G02F 1/133528; G02F 1/133514; G02F 1/1337; G02F 1/1339; G02F 1/133553; G02F 2001/133548; G02F 2202/36; G02F 2001/133628

(57) ABSTRACT

The present disclosure provides a backlight module and a display device. The backlight module includes a substrate, a plurality of light sources arranged at one side of the substrate, and a graphite thermal conduction layer arranged at the other side of the substrate.

### CROSS-REFERENCE TO RELATED APPLICATION

The present application claims a priority of the Chinese patent application No. 201410568932.6 filed on Oct. 22, 2014, which is incorporated herein by reference in its entirety.

### TECHNICAL FIELD

The present disclosure relates to the field of display technology, in particular to a backlight module and a display device.

### BACKGROUND

During the manufacture of a liquid crystal display device, usually an aluminum substrate is used to dissipate heat generated by a light source in a body of the liquid crystal display device. To be specific, the aluminum substrate is fixed to the body through a screw, so as to dissipate the heat from the light source.

However, it is found that the heat will be dissipated through the aluminum substrate in a less effective manner during the long-term use of the body, and the heat from the light source will not be dissipated in time. At this time, the light source will be always at a high temperature and serious light attenuation will occur. As a result, the brightness and a service life of the light source, and thereby the quality of the final product, will be adversely affected.

### SUMMARY

An object of the present disclosure is to provide a backlight module and a display device, so as to prevent the occurrence of serious light attenuation for a light source due to a non-ideal heat-dissipation effect caused when an aluminum substrate is used to dissipate heat from the light source, thereby to prolong a service life of the light source.

In one aspect, the present disclosure provides in one embodiment a backlight module, including a substrate, a plurality of light sources arranged at one side of the substrate, and a graphite thermal conduction layer arranged at the other side of the substrate.

Alternatively, the substrate is a printed circuit board made of aluminum.

Alternatively, the graphite thermal conduction layer is coated onto the substrate.

Alternatively, the light source is a light-emitting diode (LED) lamp.

Alternatively, the graphite thermal conduction layer is of a sheet-like shape, and the sheet-like graphite thermal conduction layer is adhered onto the substrate.

Alternatively, the backlight module further includes a back plate of a body, and the substrate is arranged at two side portions of the back plate.

Alternatively, via-holes are provided at two side portions at a bottom of the back plate.

Alternatively, the via-hole is formed obliquely.

In another aspect, the present disclosure provides in one embodiment a display device including the above-mentioned backlight module.

Alternatively, the display device further includes an upper substrate and a lower substrate arranged opposite to each other to form a cell. An upper polarizer is arranged at an upper surface of the upper substrate, a color filter layer is arranged at a lower surface of the upper substrate, a wire-grid polarizer and an array layer are arranged at an inner surface of the lower substrate, an alignment layer is arranged at an inner surface of each of the upper and lower substrates, a liquid crystal layer is arranged between the upper substrate and the lower substrate and sealed with a sealant at its periphery, nano-particles are arranged at an outer surface of the lower substrate, and a reflector is arranged on the surface where the nano-particles are arranged.

According to the backlight module and the display device in the embodiments of the present disclosure, the heat generated in the body is dissipated through the graphite thermal conduction layer. Depending on the characteristics of graphite itself, the graphite thermal conduction layer has thermal conductivity up to 1000 w/mk in a horizontal direction. The graphite thermal conduction layer may be arranged, and used to dissipate the heat, in a direction identical to a hot gas flow direction. As a result, it is able to improve the heat dissipation efficiency maximally, thereby to prevent the occurrence of light attenuation and prolong a service life of the light source.

### BRIEF DESCRIPTION OF THE DRAWINGS

FIG. 1 is a schematic view showing a backlight module according to one embodiment of the present disclosure;

FIG. 2 is a top view of via-holes in the backlight module according to one embodiment of the present disclosure; and

FIG. 3 is a side view of the via-holes in the backlight module according to one embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure.

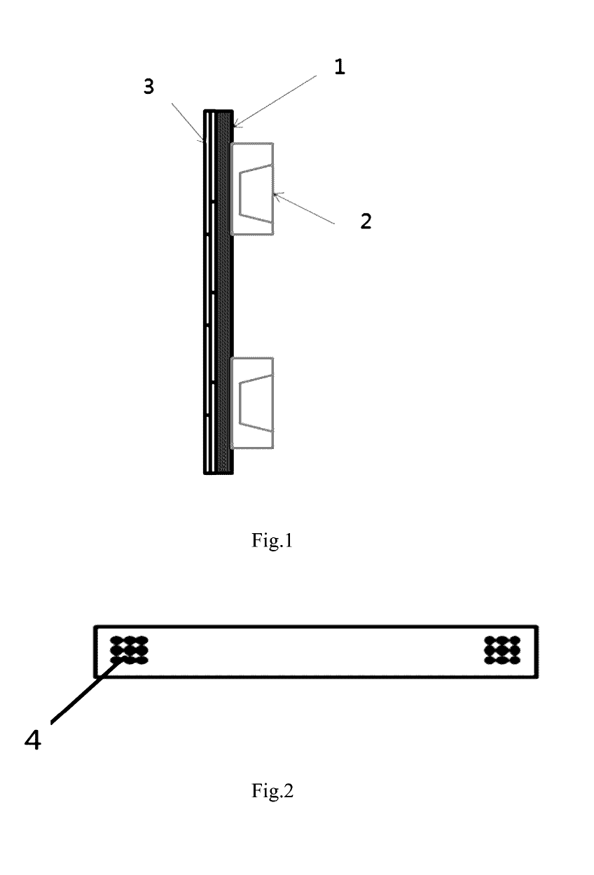

As shown in FIG. 1, the present disclosure provides in one embodiment a backlight module, which includes a substrate 1, a plurality of light sources 2 arranged at one side of the substrate, and a graphite thermal conduction layer 3 arranged at the other side of the substrate.

According to the backlight module in the embodiments of the present disclosure, the heat generated in a body is dissipated through the graphite thermal conduction layer. Depending on the characteristics of graphite itself, the graphite thermal conduction layer has thermal conductivity up to 1000 w/mk in a horizontal direction. The graphite thermal conduction layer may be arranged, and used to dissipate the heat, in a direction identical to a hot gas flow direction. As a result, it is able to improve the heat dissipation efficiency maximally, thereby to prevent the occurrence of light attenuation and prolong a service life of the light source.

It should be appreciated that, many experiments have shown that, in terms of economics or in terms of manufacture processes and heat dissipation efficiency, graphite is an optimal material for the thermal conduction layer. As an advanced nano-composite material, graphite may be adapted to any surfaces so as to achieve uniform thermal conduction. In addition, graphite may be used to shield electromagnetic interference (EMI), and meanwhile it has unique grain alignment so as to enable the uniform thermal conduction in two directions.

To be specific, during the actual application, the light sources 2 may be LED lamps distributed on the substrate 1. In order to facilitate the heat dissipation, the substrate is a printed circuit board (PCB) made of aluminum. Of course, apart from aluminum, the PCB may also be made of any other materials with physical properties identical or similar to aluminum.

The graphite thermal conduction layer may be directly coated onto the substrate 1. Of course, the graphite thermal conduction layer may be of a sheet-like shape, and the sheet-like graphite thermal conduction layer may be adhered onto the substrate 1. Such a sheet-like structure may be adapted to any surfaces in a better manner. The coating and adhesion modes are simple and easily implemented.

In addition, the backlight module further includes a back plate of the body, and the substrate 1 is arranged at two ends of the back plate so as to form, together with the LED lamps, an edge-type light source.

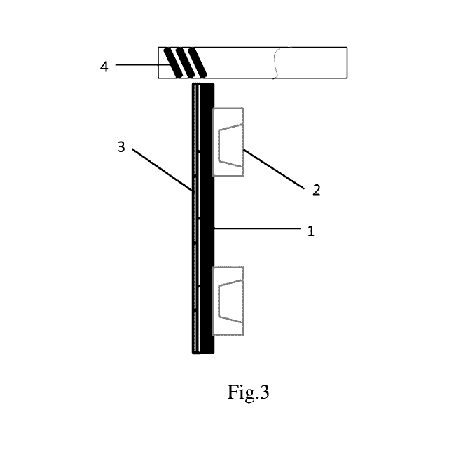

As shown in FIGS. 2-3, via-holes 4 are provided at two ends at a bottom of the back plate. In order to prevent the heat dissipation from being adversely affected due to the dust and to prevent the light leakage, the via-holes 4 may be formed obliquely.

The present disclosure further provides in one embodiment a display device including the above-mentioned backlight module. The display device further includes an upper substrate and a lower substrate arranged opposite to each other to form a cell. An upper polarizer is arranged at an upper surface of the upper substrate, a color filter layer is arranged at a lower surface of the upper substrate, a wire-grid polarizer and an array layer are arranged at an inner surface of the lower substrate, an alignment layer is arranged at an inner surface of each of the upper and lower substrates, a liquid crystal layer is arranged between the upper substrate and the lower substrate and sealed with a sealant at its periphery, nano-particles are arranged at an outer surface of the lower substrate, and a reflector is arranged on the surface where the nano-particles are arranged.

According to the display device in the embodiments of the present disclosure, the heat generated in the body is dissipated through the graphite thermal conduction layer. Depending on the characteristics of graphite itself, the graphite thermal conduction layer has thermal conductivity up to 1000 w/mk in a horizontal direction. The graphite thermal conduction layer may be arranged, and used to dissipate the heat, in a direction identical to a hot gas flow direction. As a result, it is able to improve the heat dissipation efficiency maximally, thereby to prevent the occurrence of light attenuation and prolong a service life of the light source.

The display device may be an electronic product such as a liquid crystal display panel, a liquid crystal display device, a flat-panel PC, a laptop PC or an electronic book.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A backlight module, comprising:
a substrate;
a plurality of light sources arranged at one side of the substrate; and
a graphite thermal conduction layer arranged at the other side of the substrate.

2. The backlight module according to claim 1, wherein the graphite thermal conduction layer is coated onto the substrate.

3. The backlight module according to claim 1, wherein the graphite thermal conduction layer is of a sheet-like shape, and the sheet-like graphite thermal conduction layer is adhered onto the substrate.

4. The backlight module according to claim 1, wherein the light source is a light-emitting diode (LED) lamp.

5. The backlight module according to claim 1, wherein the substrate is a printed circuit board made of aluminum.

6. The backlight module according to claim 1, further comprising a back plate of a body, wherein the substrate is arranged at two side portions of the back plate.

7. The backlight module according to claim 6, wherein via-holes are provided at two side portions at a bottom of the back plate.

8. The backlight module according to claim 7, wherein the via-hole is formed obliquely.

9. A display device, comprising the backlight module according to claim 1.

10. The display device according to claim 9, further comprising an upper substrate and a lower substrate arranged opposite to each other to form a cell,
wherein an upper polarizer is arranged at an upper surface of the upper substrate, a color filter layer is arranged at a lower surface of the upper substrate,
a wire-grid polarizer and an array layer are arranged at an inner surface of the lower substrate,
an alignment layer is arranged at an inner surface of each of the upper and lower substrates,
a liquid crystal layer is arranged between the upper substrate and the lower substrate and sealed with a sealant at its periphery,
nano-particles are arranged at an outer surface of the lower substrate, and
a reflector is arranged on the surface where the nano-particles are arranged.

11. The backlight module according to claim 2, wherein the light source is a light-emitting diode (LED) lamp.

12. The backlight module according to claim 2, wherein the substrate is a printed circuit board made of aluminum.

13. The backlight module according to claim 2, further comprising a back plate of a body, wherein the substrate is arranged at two side portions of the back plate.

14. The backlight module according to claim 3, wherein the light source is a light-emitting diode (LED) lamp.

15. The backlight module according to claim 3, wherein the substrate is a printed circuit board made of aluminum.

16. The backlight module according to claim 3, further comprising a back plate of a body, wherein the substrate is arranged at two side portions of the back plate.

17. The backlight module according to claim 4, wherein the substrate is a printed circuit board made of aluminum.

18. The backlight module according to claim 4, further comprising a back plate of a body, wherein the substrate is arranged at two side portions of the back plate.

19. The backlight module according to claim 5, further comprising a back plate of a body, wherein the substrate is arranged at two side portions of the back plate.

20. A display device, comprising the backlight module according to claim 2.
